(19) United States
(12) Patent Application Publication
(10) Pub. No.: US 2011/0220754 A1
(43) Pub. Date: Sep. 15, 2011

(54) CORD STORAGE SYSTEM

(76) Inventors: David J. Merten, Manitowoc, WI (US); Jay Z. Muchin, Manitowoc, WI (US); Michael M. Potempa, Freeport, IL (US); Brian S. Potempa, Freeport, IL (US)

(21) Appl. No.: 12/723,638

(22) Filed: Mar. 13, 2010

(51) Int. Cl. H02G 11/02; B65H 75/44

(52) U.S. Cl. 242/400.1

(57) ABSTRACT

An apparatus and method facilitate storage of an extension cord about one or more hooks on an electrically powered appliance.

### BACKGROUND

Many existing electrically powered portable appliances require use of an extension cord. Unfortunately, use of the portable electric powered appliances is often difficult as the extension cords frequently catch on various obstructions and often become tangled.

### BRIEF DESCRIPTION OF THE DRAWINGS

FIG. 1 is a side elevational view of an example cord storage system mounted to an electric powered appliance, portions of which are schematically shown.

FIG. 2 is a perspective view of the cord storage system of FIG. 1, illustrating hooks of the cord storage system at different spacings as compared to those shown in FIG. 1.

FIG. 3 is a fragmentary front elevational view of the cord storage system of FIG. 1 illustrating a claw of a hook pivoting from a cord winding retaining position to cord winding releasing positions.

FIG. 4 is a fragmentary side elevational view of another embodiment of the cord storage system of FIG. 1 illustrating a claw of a hook pivoting from a cord winding retaining position to cord winding releasing position.

FIG. 5 is a fragmentary side elevational view of another embodiment of the cord storage system of FIG. 1 illustrating a claw of a hook translating from a cord winding retaining position to cord winding releasing position.

FIG. 6 is a perspective view of the cord storage system of FIG. 1 mounted to a trimmer according to an example embodiment.

FIG. 7 is a sectional view of the cord storage system of FIG. 6, with portions schematically shown.

FIG. 8 is a perspective view of the cord storage system of FIG. 1 mounted to a blower/vacuum according to an example embodiment.

FIG. 9 is a sectional view of the cord storage system of FIG. 8, with portions schematically shown.

FIG. 10 is a perspective view of the cord storage system of FIG. 1 mounted to a walk behind mower according to an example embodiment.

FIG. 11 is a sectional view of the cord storage system of FIG. 10, with portions schematically shown.

FIG. 12 is a top perspective view of a particular embodiment of the hook of the cord storage system of FIG. 1.

FIG. 13 is an exploded perspective view of the hook of FIG. 12.

FIG. 14 is a sectional view of the hook of FIG. 12.

FIG. 15 is a sectional view of the hook of FIG. 12.

### DETAILED DESCRIPTION OF THE EXAMPLE EMBODIMENTS

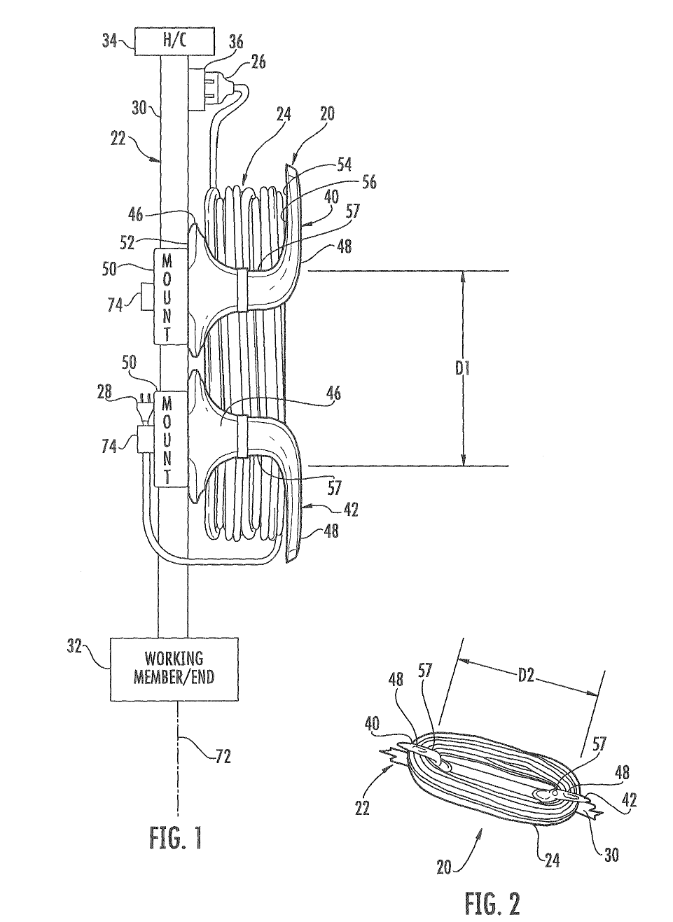

FIG. 1 illustrates an example cord storage system 20 mounted on an electrically powered appliance 22 and storing an electrical extension cord wound in a winding and having a male plug 26 and a female plug 28. As will be described hereafter, cord storage system 20 provides a versatile cord storage system that may be easily adjusted to accommodate different extension cord lengths and that may be mounted to a variety of different electrically powered appliances having different shapes and sizes. As a result, cord storage system 20 makes the use of existing portable electrically powered appliances more convenient and hassle free.

Powered appliance 22 comprises an electrically powered portable powered appliance configured to be manually carried, to be manually pushed or driven. In the example illustrated, powered appliance 22 comprises a piece of outdoor power equipment. Electrically powered appliance 22 includes a longitudinally extending structure 30, a working member/end 32, a handle/controller 34 and a male electrical power receiving plug 36. Structure 30 extends between the working member or working end 32 and the handle/controller 34. Structure 30 may have a variety of sizes, shapes and configurations and may perform a variety of functions. For example, when appliance 22 comprises a blower or vacuum, charger 22 may comprise an elongate tube for directing pressurized air. When appliance 22 comprises a trimmer, tiller or motor, structure 22 may comprise a shaft connecting handle 34 to be working member or end 32.

Working member or end 32 comprises that portion of appliance 22 by which the functional appliance 22 is carried out. Working member/end 32 may have a variety of different configurations depending upon the function to be performed. For example, when appliance 22 comprises a vacuum or blower, end 32 may comprise a nozzle or terminus of the tube provided by structure 30. When appliance 22 comprises a mower, working member/end 32 may comprise the engine and the driven blade or blades of the mower. When appliance 22 comprises a trimmer, end 32 may comprise one or blades, strings or the like driven by an engine which may be at working end 32 or which may be more proximate to handle 34.

Handle/controller 34 comprises that portion of appliance 22 by which appliance 22 is manually carried, manually pushed or manually steered. In particular embodiments, handle/controller 34 may additionally include mechanical or electrical controls for controlling the operation of appliance 22. Although working member/end 32 and handle/controller 34 are illustrated as extending on opposite ends of structure 30, in other embodiments, this relationship may be changed.

Plug 36 comprises a male electrical plug having two or more prongs configured to mate it with and be received within corresponding sockets of female plug 26 of extension cord 24. Plug 36 facilitates electrical connection of extension cord 24 to appliance 22 such that electrical power may be supplied to appliance 22 as appliance 22 is moved about, carried or transported. In the example illustrated, plug 36 is located proximate to handle such controller 34. In other embodiments, plug 36 may be provided at other locations.

Cord storage system 20 removably mounts to appliance 22 and stores a winding of cord 24. Cord storage system 20 includes hooks 40 and 42. In the example illustrated, hooks 40 and 42 are substantially identical to one another, but are mounted to appliance 22 in opposite directions. In other embodiments, hooks 40, 42 may have different configurations. Each of hooks 40, 42 comprises a base 46, a claw 48 and a mount 50.

Base 46 comprises a structure configured to be mounted to appliance 22. In the example illustrated, base 46 has a lower concave surface 52 at least partially or somewhat conforming to an exterior surface of structure 30 of appliance 22. Base 46 is secured to structure 30 by mount 50 and supports claw 48.

Claw 48 projects and extends from base 46. Claw 48 has a structure facing surface 54 which cooperates with at least base 46 to form a cord winding receiving recess 56 which is bounded on opposite sides by base 46 and surface 54 of claw 48. In some embodiments, surface 54 may additionally or alternatively extend opposite to structure 30 to form cord winding receiving recess 56. Recess 56 receives the winding of cord 24, wherein opposite side of the winding are contacted by one or more of surface 54, base 46 and structure 30.

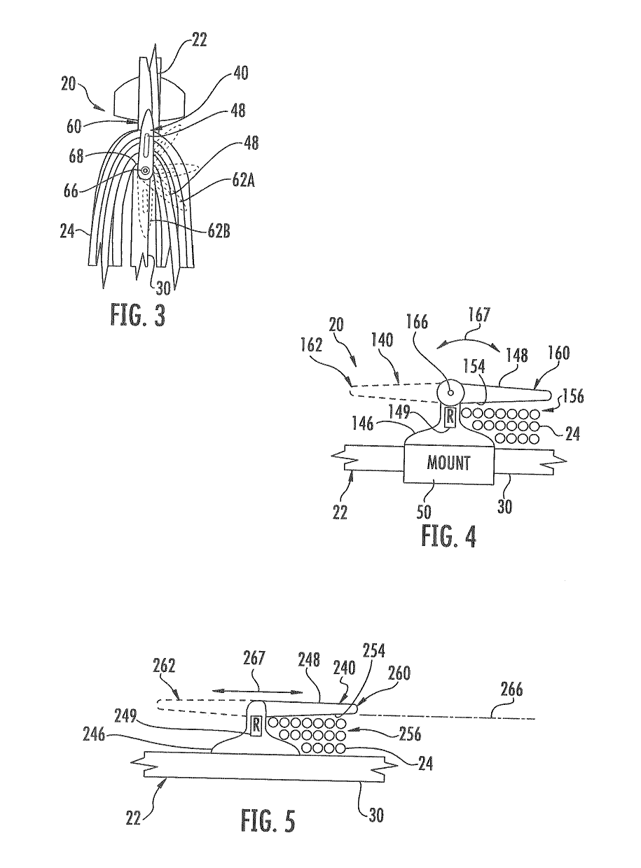

As shown by FIG. 1, claws 48 of hooks 40 and 42 are mounted to structure 30 of appliance 22 so as to extend in substantially opposite directions. As a result, cord winding receiving recesses 56 of hooks 40, 42 also extend in opposite directions to retain and capture the winding of cord 24. As shown by FIG. 3, at least one of claws 48 is movably coupled to its associated base 46 for movement relative to the associated base 46 between a cord winding retaining position 60 in which the cord winding recess 56 is formed and one or more cord winding releasing positions 62A, 62B (shown in broken lines). When claw 48 is in a cord winding releasing position, claw 48 does not capture an entirety of the winding of cord 24 such that at least a portion of the winding of cord 24 may be withdrawn away from structure 30 and the particular hook 40, 42. In particular, multiple loops of the end of the winding of cord 24 may be simultaneously moved in a direction parallel to the one of more axes about which the winding of the cord 24 extends. Rather than unwinding cord 24 around hooks 40, 42, the entire or a large portion of the winding may be pulled off the hooks 40, 42 at once. As a result, the winding may be more easily separated from appliance 22 to simplify unwinding of cord 24 to provide a greater length such as when appliance 22 is to be used at a farther distance from an electrical power source.

In the example shown in FIG. 3, claw 48 of each hook 40, 42 is pivotally connected to base 46 so as to pivot about axis 66 from the cord winding retaining position 60 to one of the cord winding releasing positions 62. As shown by FIG. 3, the extent to which the cord winding is retained on appliance 22 may be controlled by the angle at which hook 48 is rotated about axis 66. In position 62A, only a part of the winding may be pulled or transversely moved off of hooks 40, 42. In position 62B, wherein book 48 extents substantially parallel to structure 30 of appliance 22, all of the winding of cord 24 may be transversely moved off of the hook 40, 42 shown. When claws 48 of both hooks 40, 42 are moved to position 62B, the entire winding up for 24 (both ends of the winding) may be linearly moved off of hooks 40, 42.

In one embodiment, claw 48 of each of hooks 40, 42 is retained in a selected position by means of friction between claw 48 and base 46. In another embodiment, claw 48 may be resiliently biased towards the cord winding retaining position. For example, one embodiment, claw 48 may be resiliently biased towards the cord winding retaining position by a torsion spring 68 coupled between claw 48 and base 46. In yet other embodiments, other retaining mechanism may be employed to retain or bias claw 48 to a selected position. Although hooks 40, 42 have been described as being identical to one another for ease of use, in other embodiments, hooks 40, 42 may be distinct from one another such as where one of hooks 40, 42 does not include a movable claw 48 or includes a claw 48 which is movable relative to base 46 in a different manner as compared to the other hook.

FIG. 4 illustrates hook 140, another embodiment of hook 40, mounted upon structure 30 of appliance 22. In such an embodiment, hook 42 (shown in FIG. 1) may also be replaced with a hook similar to hook 140 shown. Hook 140 includes base 146, claw 148, retainer 149 and mount 50. Base 146 is similar to base 46 except that base 146 is pivotally coupled to claw 1486 on 148 may pivot about axis 166 between a cord winding retaining position 160 in a cord winding releasing position 162 (shown in broken lines).

Claw 148 is similar to claw 48 except that claw 148 pivots about axis 166 as indicated by arrows 167. As with claw 48, claw 148 cooperates with at least base 146 to form a cord winding receiving recess 156 which is bounded on opposite sides by base 146 and surface 154 of claw 48. In some embodiments, surface 154 may additionally or alternatively extend opposite to structure 30 to form cord winding receiving recess 156. Recess 156 receives the winding of cord 24, wherein opposite side of the winding are contacted by one or more of surface 154, base 146 and structure 30.

Retainer 149 (schematically shown) comprises a structure configured to retain claw 148 in a selected angular position about axis 166 with respect to structure 30. In one embodiment, retainer 149 selectively retains claw 148 in either the cord winding retaining position 160 or the cord winding releasing position 162. In one embodiment, retainer 149 includes one of a projection and a detent supported by base 146 and the other of a projection and a detent supported by claw 148, wherein the projection and the detent are resiliently biased into engagement with one another (the detent receiving the projection) and wherein manually applied force against the bias withdraws the projection from the detent to allow claw 148 to be pivot about axis 166 relative to base 146. In another embodiment, retainer 149 may alternatively or additionally include a bias resiliently biasing claw 148 towards the cord winding retaining position 160. For example, in one embodiment, retainer 149 comprises a torsion spring connected between claw 148 and base 146 so as to resiliently bias claw 148 towards position 160. In other embodiments, retainer 149 merely comprises two contacting interfaces which frictionally hold claw 148 relative to base 146.

FIG. 5 illustrates hook 240, another embodiment of hook 40, mounted upon structure 30 of appliance 22. In such an embodiment, hook 42 (shown in FIG. 1) may also be replaced with a hook similar to hook 240 shown. Hook 240 includes base 246, claw 248, retainer 249 and mount 50. Base 246 is similar to base 46 except that base 246 slidably supports claw 248 such that claw 248 may linearly translate or slide relative to base 246 between a cord winding retaining position 260 and a cord winding releasing position 262 (shown in broken lines).

Claw 248 is similar to claw 48 except that claw 248 linearly translates along axis 266 as indicated by arrows 267. As with claw 48, claw 248 cooperates with at least base 246 to form a cord winding receiving recess 256 which is bounded on opposite sides by base 246 and surface 254 of claw 248. In some embodiments, surface 254 may additionally or alternatively extend opposite to structure 30 to form cord winding receiving recess 256. Recess 256 receives the winding of cord 24, wherein opposite side of the winding our contacted by one or more of surface 254, base 246 and structure 30.

Retainer 249 (schematically shown) comprises a structure configured to retain claw 248 in a selected position along axis 266 with respect to structure 30. In one embodiment, retainer 249 selectively retains claw 248 in either the cord winding retaining position 160 or the cord winding releasing position 162. In one embodiment, retainer 249 includes one of a projection and a detent supported by base 246 and the other of a projection and a detent supported by claw 248, wherein the projection and the detent are resiliently biased into engagement with one another (the detent receiving the projection) and wherein manually applied force against the bias withdraws a projection from the detent to allow claw 248 to be linearly translated axis 266 relative to base 246. In another embodiment, retainer 249 may alternatively or additionally include a bias resiliently biasing claw 248 towards the cord winding retaining position 160. For example, in one embodiment, retainer 249 comprises a tension or compression spring connected between claw 248 and base 246 so as to resiliently bias claw 248 towards position 260. In other embodiments, retainer 249 merely comprises two contacting interfaces which frictionally hold claw 248 relative to base 246.

Referring back to FIG. 1, mount 50 of each of hooks 40, 42 comprises a mechanism configured to movably mount base 46 to structure 30 of appliance 22, allowing its associated hook 40, 42 to be slid or longitudinally moved along structure 30 relative to the other hook 40, 42. In the example illustrated, mount 50 is configured to allow the base 46 to slide or linearly move along the axis of structure 30 relative to structure 30.

In the example illustrated, each mount 50 releasably and removably mounts or couples base 46 to structure 30. For purposes of this disclosure, a structure is removably mounted to another structure when the structures may be completely separated from one another without damage or permanent deformation of either of such structures. Because mount 50 removably mounts base 46 to structure 30 of appliance 22, hooks 40, 42 may be selectively located at a variety of different locations or positions along the longitudinally extending structure 30, at a variety of selected positions along axis 72 of structure 30. As a result, hooks 40, 42 may be variably mounted to different electrically powered appliances to accommodate different potential mounting locations provided by different appliances. For example, a walk-behind lawnmower, a handheld blower, a tiller and a hand held trimmer may each offer potential mounting locations that are differently spaced from one another. Mount 50 of each of hooks 40, 42 (or of hooks 140, 240) allows a person to select mounting locations on the electrically powered appliance that are most appropriate, that are less likely to interfere with the person's use of the powered appliance and that accommodate the person's personal preferences (i.e., different locations depending upon whether the person is left-handed or right-handed).

In addition to facilitating the use of hooks 40, 42 on multiple differently configured electrically powered appliances, mount 50 of each of hooks 40, 42 also facilitates the repositioning of hooks 40, 42 at selected spacings or distances from one another to accommodate different lengths of one or more cords 24. For example, FIG. 1 illustrates hooks 40, 42 wherein the oppositely facing innermost surfaces 57 are spaced from one another by a distance D1. FIG. 2 illustrates hooks 40, 42 wherein the oppositely facing innermost surfaces 57 are spaced from one another by a distance D2 greater than the distance D2. At distance D2, hooks 40, 42 may accommodate a larger length of cord 24. Thus, mount 50 enables hooks 40, 42 to be mounted to an electrically powered appliance 22 at spaces which maximize the length of cord 24 that may be carried and stored by storage system 20. At the same time, in those circumstances where a person does not need an extremely long cord 24, mount 50 enables hooks 40, 42 to alternatively be mounted closer to one another at locations where the hooks 40, 42 are less likely to interfere with the person's use of appliance 22.

As further shown by FIG. 1, mounts 50 each additionally include a cord end retainer 74. Cord end retainer 74 comprises structure configured to resiliently flex, bend or deform about cord 24 adjacent to plug 28 so as to removably retain cord 24 relative to mount 50. In other embodiments, retainer 74 may be provided on other portions of hooks 40, 42 or may be omitted. In yet other embodiments, retainer 74 may have other configurations, such as a hook and loop fastening strap for wrapping about cord 20 proximate to plug 28.

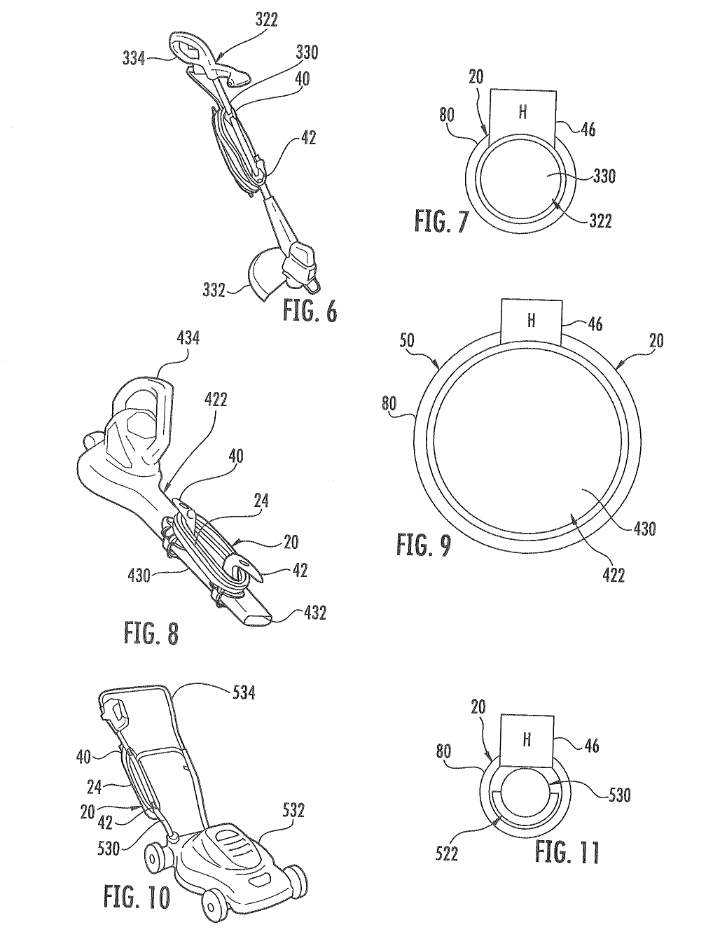

As further shown by FIGS. 6-11, mount 50 removably mounts base 46 to electrically powered appliances by extending about structures associated with such appliances. In the example illustrated, mount 50 includes one or more flexible straps 80 extending from base 46, wrapping at least partially about the electrically powered appliance and having an adjustable collective length. As a result, mount 50 is configured to accommodate differently shaped or differently sized mounting locations or portions of different electrically powered appliances.

FIGS. 6 and 7 illustrate mounting system 20 removably mounted to a longitudinally extending structure 330 of an electrically powered appliance 322 comprising a weed or grass trimmer. FIG. 6 illustrates hooks 40, 42 mounted at spaced locations along shaft (structure 330) extending between handle 334 and the working end 332 of appliance 322. As shown by FIG. 7, the one or more straps 80 encircle the outer circumference of structure 330.

FIGS. 8 and 9 illustrate mounting system 20 removably mounted to a longitudinally extending structure 430 of an electrically powered appliance 422 comprising a blower or vacuum. FIG. 8 illustrates hooks 40, 42 mounted at spaced locations along a blower tube (structure 430) extending between handle 434 and the air discharge or vacuum end 432 of appliance 422. As shown by FIG. 8, the one or more straps 80 encircle the outer circumference of structure 430.

FIGS. 10 and 11 illustrate mounting system 20 removably mounted to a longitudinally extending structure 530 of an electrically powered appliance 522 comprising a walk-behind mower. FIG. 10 illustrates hooks 40, 42 mounted at spaced locations along a bail arms extending between handle 534 and the mower bed of appliance 522. As shown by FIG. 11, the one or more straps 80 wrap about the outer perimeter of structure 530.

As shown by FIGS. 7, 9 and 11, the one more straps 80 of mount 50 enables hooks 40, 42 to be removably mounted to longitudinally extending structures 330, 430 and 530 of different appliances having different diameters and different shapes. In particular, the outer diameter of structure 430 is much greater than the outer diameter of structure 330. Structures 330 and 430 have circular or tubular cross-sections, structure 530 has a non-circular cross-section as it is formed from two overlapping members. Because the one more straps 80 are flexible and have an adjustable length, the one or more straps 80 may accommodate multiple different mounting location configurations. As a result, cord storage system 20 is a versatile in its ability to be mounted to multiple distinct electrically powered appliances.

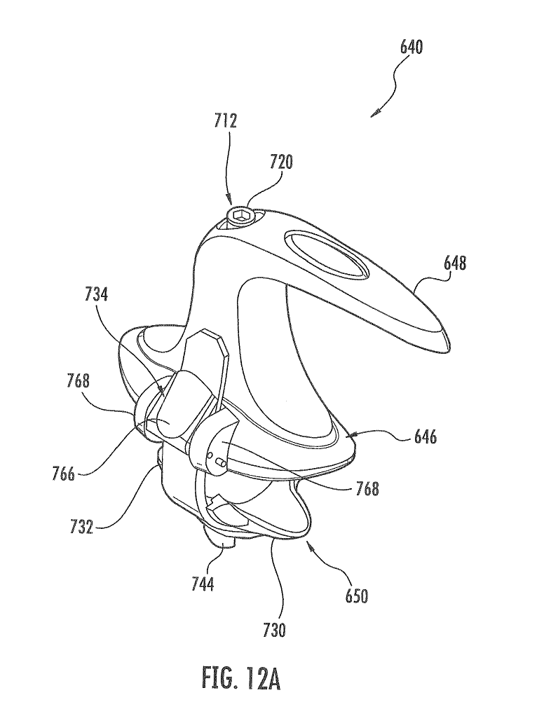

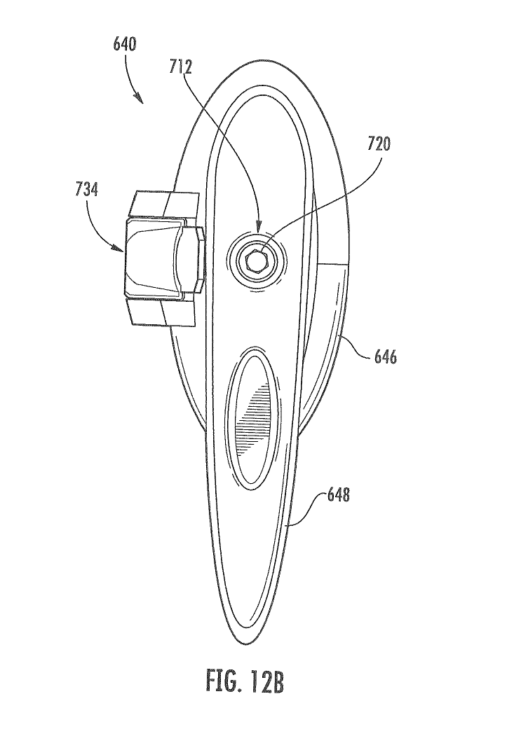

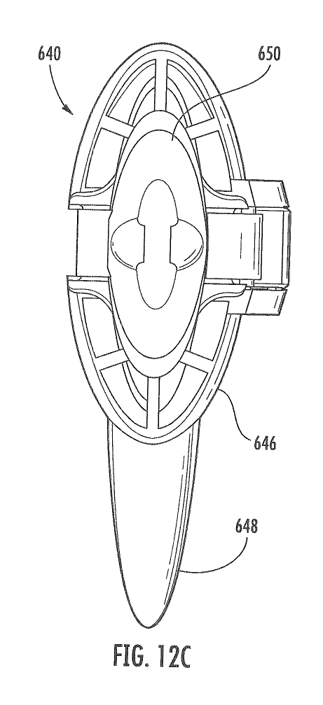

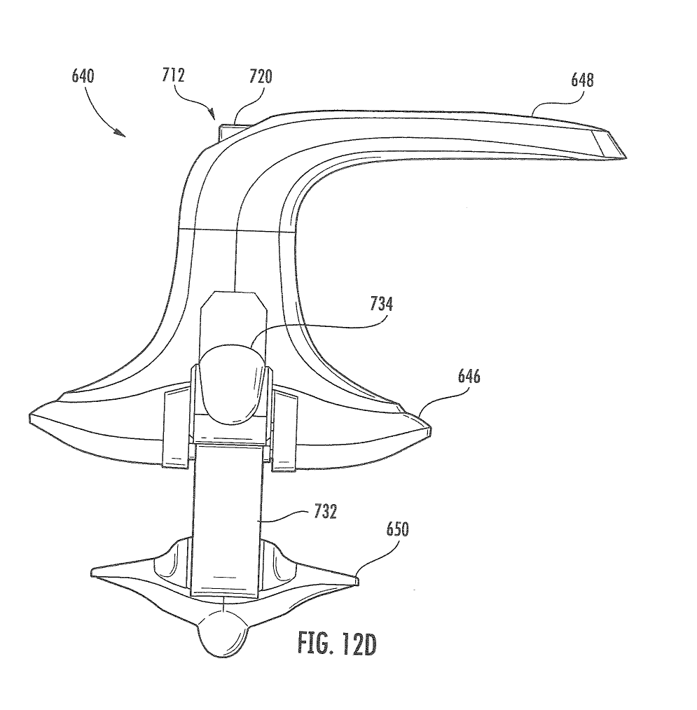

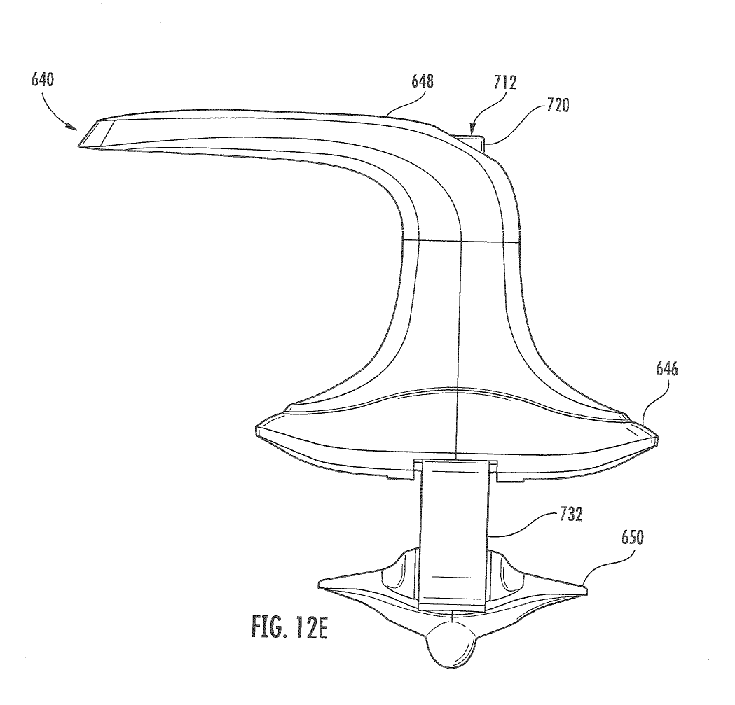

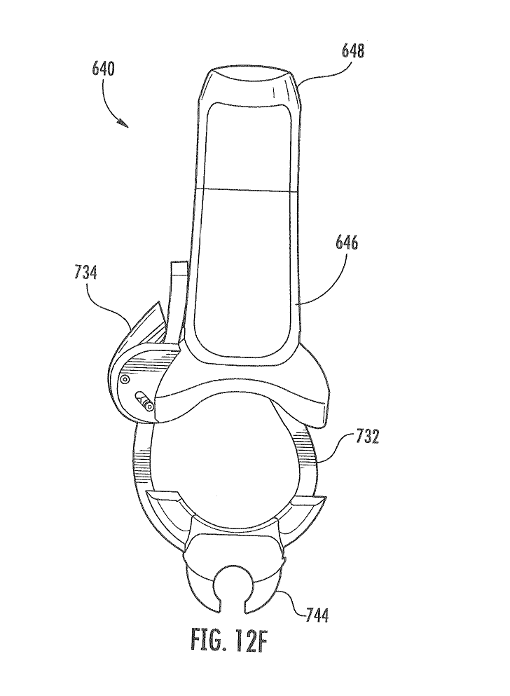

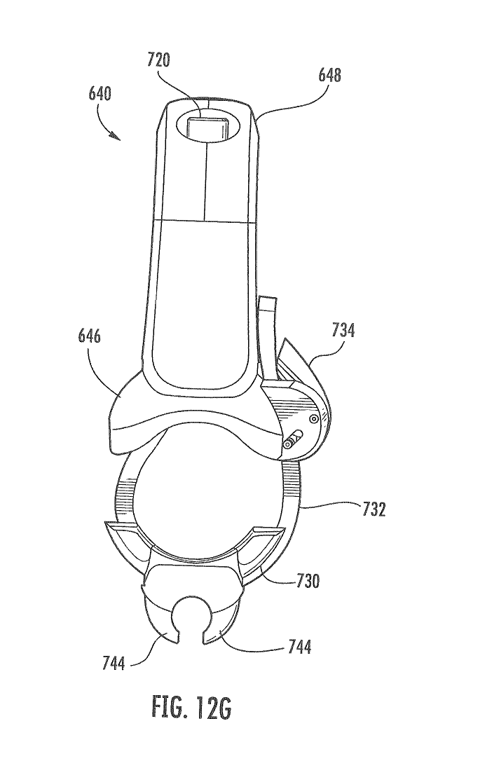

FIGS. 12-15 illustrate hook 640, an example embodiment of hook 40 (or hook 42). Hook 640 comprises base 646, claw 648 and mount 650. Base 646 comprises a structure configured to be mounted to appliance 22. Base 46 is secured to structure 30 by mount 50 and supports claw 48.

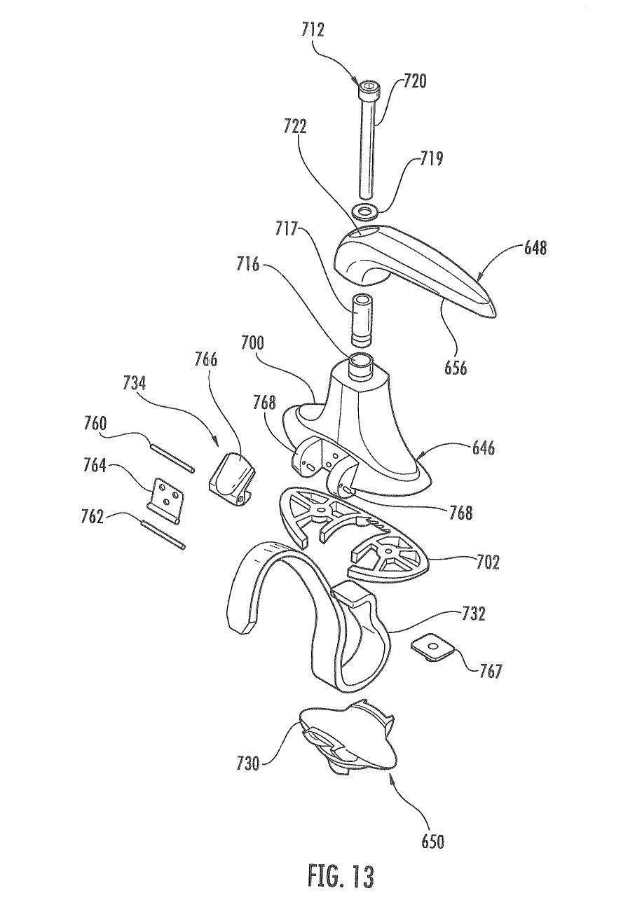

As shown by FIG. 13, base 646 includes body 700 and pad 702. Body 700 supports claw 648 and is further connected to mount 650. Pad 702 is adapted to be sandwiched between body 700 and structure 30 of appliance 22 (shown in FIG. 1). In the example illustrated, body 70 is formed from one or more polymers while pad 702 is formed from one or more soft or rubber-like polymers or rubbers to facilitate gripping or frictional retention of base 646 on the electrically powered appliance. In other embodiments, body 700 and pad 702 may have other configurations and may be formed from other materials.

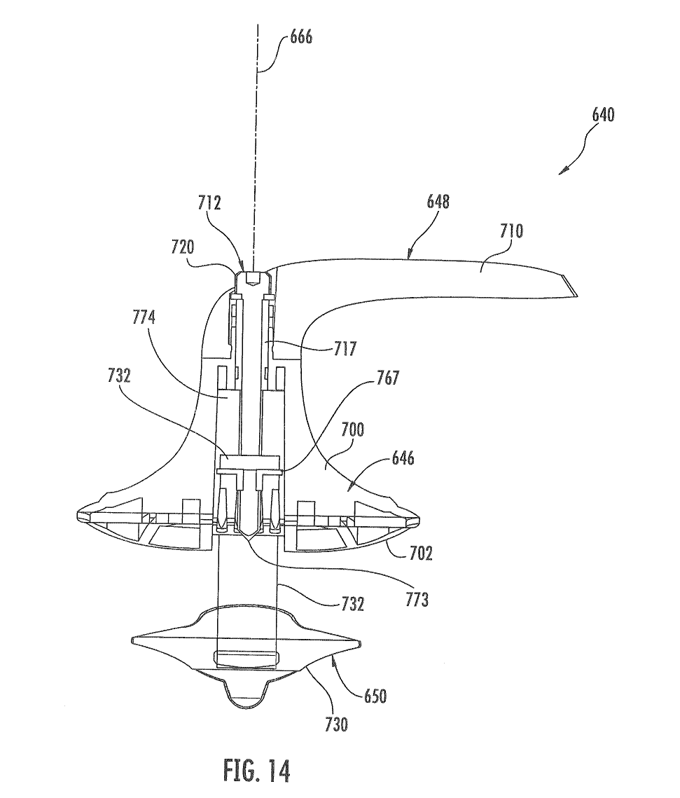

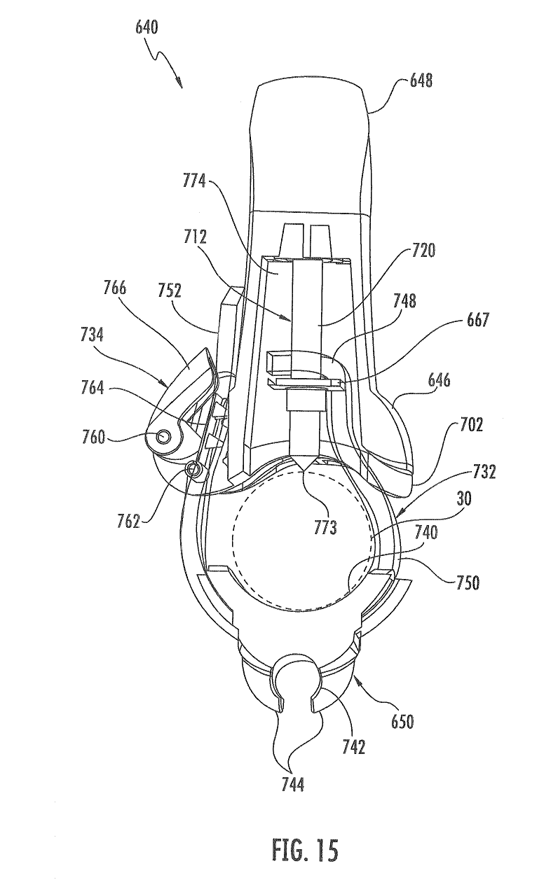

Claw 648 projects and extends from base 646. Claw 648 has a structure facing surface 654 which cooperates with at least base 646 to form a cord winding receiving recess 656 which is bounded on opposite sides by base 646 and surface 654 of claw 648. Claw 648 is pivotally connected to base 646 so as to pivot about axis 666 (shown in FIG. 14) from the cord winding retaining position 60 to one of the cord winding releasing positions 62 (shown in FIG. 3).

As shown by FIGS. 13-15, claw 648 comprises body 710 and pivot mechanism 712. Body 710 projects from base 646 and provides surface 656. Pivot mechanism 712 pivotally connects body 648 to base 646. In the example illustrated, pivot mechanism 712 includes pivot bore 716, insert post 717, washer 719 and socket screw 720. Pivot bore 716 comprises a bore extending into base 646. Insert post 717 is received within pivot bore 716 and itself receives socket screw 720. Grommet 767 is retained upon insert post 717 and includes an internally threaded bore. Socket screw 720 extends through insert post 717 and is threaded into or through grommet 767. Washer 767 is captured between the head of screw 720 and body 710 to capture and retain body 710 against base 646. In other embodiments, other mechanisms may be used to pivotally couple hook 648 to base 646.

Mount 650 comprises a mechanism configured to releasably and removably mount base 646 to structure 30 of appliance 22 (shown in FIG. 1). Because mount 50 removably mounts base 646 to structure 30 of appliance 22, hook 640 may be selectively located at a variety of different locations or positions along the longitudinally extending structure 30. As a result, hook 640 may be variably mounted to different electrically powered appliances to accommodate different potential mounting locations provided by different appliances. As with mount 50, mount 650 wraps about portions of the appliance to enable hook 642 mounted to differently size and differently shaped mounting locations.

As shown by FIGS. 13 and 14, mount 650 includes base opposing pad 730, strap 732 and strap connector and adjuster 734. Base opposing pad 730 comprises structure configured to extend substantially opposite to base 646 on a substantially opposite side of structure 30 of appliance 22 (shown in FIG. 1). As shown by FIG. 15, base opposing pad 730 has a concave surface 740 configured to abut structure 30. In the example illustrated, surface 740 is formed from one of more rubber or rubber-like materials providing a high level of friction between surface 740 and structure 30. As a result, hook 648 of those likely to slide along structure 22 (shown here one) while holding cord 24.

Base opposing pad 730 further includes a C-shaped channel 742 having resiliently flexible opposing fingers 744 which resiliently widen or open during reception of cord 24 and which resilient return to their original shape such that the cord 24 is retained within channel 742. In other embodiments, channel 742 may be omitted. In still other embodiments, pad 730 may be omitted.

Strap 732 comprises a flexible elongate reinforced strapping having a first end 748 secured to base 646, a first intermediate portion 750 configured to wrap about structure 30 (shown FIG. 1) and extending through a channel formed within pad 730, a second intermediate portion 752 extending through adjuster 734 and a second end 754. In the example illustrated, end 748 includes an aperture through which screw 720 extends to retain end 748 to base 646. In other embodiments, end 740 may be secured to base 646 in other fashions. Although mount 650 is illustrated as including a single strap 732, in other embodiments, multiple straps may be utilized to wrap about the structure 30 of appliance 22. For example, in other embodiments, a first strap may be connected between base 646 and pad 730, wherein a second strap may be connected between pad 730 and adjuster 734.

Strap connector and adjuster 734 comprises a mechanism configured to releasably secure strap 732 to base 646 and to allow manual adjustment of a length of one or more straps, such as strap 732, wrapping about the structure 30 of the electrically powered appliance 22 (shown in FIG. 1). Strap connector and adjuster 734 facilitates the tightening and loosening strap 732 about the electrically powered appliance. As a result, mount 750 may be mounted to differently shaped and differently sized structures 30 of appliance 22. In addition, adjuster 734 allows strap 732 to be loosened such that hook 640 may be longitudinally moved or slid along the longitudinally extending structure of an electric powered appliance relative to the structure of the electrically powered appliance while strap 732 still loosely extends about or wraps about the electric powered appliance, allowing the distance separating hook 640 from another hook to be adjusted to accommodate different lengths of extension cord or different user preferences. In the example illustrated, strap connector and adjuster 734 further enables strap 732 to be completely separated from adjuster 734, allowing hook 740 to be completely removed and withdrawn from the electrically powered appliance.

As shown by FIGS. 13 and 14, in the example illustrated, adjuster 734 comprises an over-center cam mechanism including cam pins 760, 762, strap gripping plate 764, cam 766 and strap finite adjuster 767. Cam pins 760 and 762 are supported by ears 768 (shown in FIG. 13) projecting from body 646. As shown by FIG. 15, cam pin 760 pivotally supports cam 766 while cam pin 762 pivotally supports plate 764. Cam 766 rotates or pivots between a strap retaining position in which cam 766 urges and retains plate 764 into a strap holding or retaining position against strap 732 and a strap releasing position, allowing strap 732 to be pulled through adjuster 734 for either (1) gross adjustment of a length of strap 732 looping from body 646 to grossly loosen or tighten strap 732 about a structure or (2) complete disconnection from adjuster 734 such that an end of strap 732 is completely separated from body 764, allowing hook 640 to be completely removed from the structure. In other embodiments, adjuster 734 may comprise buckles or other mechanisms configured to allow adjustment of the length of strap 732 extending wrapping about the electrically powered appliance.

Strap finite adjuster 767 comprises a mechanism configured to allow further more precise adjustment of a length of strap 732. In the example illustrated, strap finite adjuster 767 comprises a threaded adjustment mechanism. In the particular embodiment illustrated, strap finite adjuster 767 comprises a threaded grommet threadably mounted upon socket screw 720 within cavity 774 base 646 between strap 732 and pad 702. Adjuster 767 is slidably or movably positioned within base 646 but is shaped so as to not rotate about socket screw 720. In the example illustrated, strap 732 is either connected to adjuster 767 or is otherwise retained or captured between adjuster 767 and claw 648. As a result, rotation of socket screw about axis 666 (shown in FIG. 14) results in adjuster 767 moving along socket screw 720 and along axis 666.

Rotation of adjuster 767 in a first direction moves adjuster towards claw 648. As adjuster 767 moves towards claw 648, adjuster 767 also moves that portion of strap 732 connected to or carried by adjuster 732 towards claw 64 so as to reduce a length of strap 732 looping from base 646 so as to tighten strap 732 about the structure of the electrically powered appliance. During such tightening of strap 732, the structure of electric powered appliance is drawn towards and against a lower end of socket screw 720. In the example illustrated, the lower end of socket screw 720 terminates at a point 773 which abuts or contacts the structure 30 (shown in broken lines) about which strap 732 wraps. As a result, the point 773 of socket screw 720 further grips the structure of the electric powered appliance to further assist in retaining book 640 relative to the electrically powered appliance.

Rotation of socket screw 720 in a second opposite direction moves adjuster away from claw 648. As adjuster 767 moves away from claw 648, adjuster 767 allows that portion of strap 732 connected to or carried by adjuster 732 to be moved or pulled towards claw 64 so as to increase a length of strap 732 looping from base 646 so as to loosen strap 732 about the structure of an electric powered appliance. This loosening or tightening of strap 732 by adjuster 767 may be performed while cam 766 is in the strap retaining position. In other embodiments, adjuster 767 may be omitted or may be provided without the over-center cam mechanism including cam pins 760, 762, strap gripping plate 764 and cam 766. In such an embodiment of mating the over center cam mechanism, the opposite end of strap 732 may be joined to base 646 in a permanent fashion or in other manners.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a first hook comprising:
a first base configured to be removably mounted to an electrically powered appliance; and
a first claw extending from the first base to form a first cord winding receiving recess; and
a second hook comprising:
a second base configured to be removably mounted to the electrically powered appliance; and
a second claw movably coupled to the second base, the second claw being movable relative to the second base between a cord winding retaining position forming a second cord winding receiving recess and a cord winding releasing position.

2. The apparatus of claim 1, wherein the second claw pivots between the cord winding retaining position and the cord winding releasing position.

3. The apparatus of claim 2, wherein the second claw pivots

4. The apparatus of claim 2, wherein the second claw pivots

5. The apparatus of claim 1, wherein the second claw slides between the cord winding retaining position and the cord winding releasing position.

6. The apparatus of claim 1, wherein the first claw is movably coupled to the first base, the first claw being movable relative to the first base between a cord winding retaining position forming the first cord winding receiving recess and a second cord winding releasing position.

7. The apparatus of claim 1, wherein the second hook further comprises a mount connected to the base and configured to removably mount the base to the electrically powered appliance.

8. The apparatus of claim 7, wherein the mount is configured to wrap about the electrically powered appliance.

9. The apparatus of claim 8, wherein the mount comprises:
a strap having a length to wrap about the electrically powered appliance; and
an over-center cam actuatable to tighten or loosen the strap about the electrically powered appliance.

10. The apparatus of claim 9 wherein the cam actuates between a strap releasing position and a strap retaining position retaining a first portion of the strap against movement and wherein the second hook additionally comprises a threaded adjustment mechanism coupled to a second portion of the strap and configured such that rotation of the threaded adjustment mechanism further tightens the strap about the electrically powered appliance while the cam is in the strap retaining position.

11. The apparatus of claim 10, wherein the threaded adjustment mechanism includes a point facing the strap and configured to be drawn towards and into contact with the electrically powered appliance as the strap is tightened about the electrically powered appliance.

12. The apparatus of claim 8, wherein the mount comprises:
an underpad opposite the base;
at least one strap connecting the underpass and the base, wherein the at least one strap and the base collectively wrap about the electrically powered appliance.

13. The apparatus of claim 8 further comprising a C-shaped channel carried by the underpad and configured to resiliently retain a cord of the cord winding against the underpad.

14. An apparatus comprising:
an electrically powered appliance having a longitudinally extending structure;
a first hook extending from the electrically powered appliance; and
a second hook extending from the longitudinally extending structure and being longitudinally movable along the longitudinally extending structure relative to the first hook.

15. The apparatus of claim 14, wherein the second hook comprises:
a first claw; and
a first mount supporting the first claw, wherein the first claw is movable relative to the structure between a first cord winding retaining position forming a cord winding receiving recess and a first cord winding releasing position.

16. The apparatus of claim 15, wherein the mount comprises:
a strap having a length to wrap about the electrically powered appliance; and
an over-center cam actuatable to tighten or loosen the strap about the electrically powered appliance.

17. The apparatus of claim 15, wherein the first claw pivots between the cord first winding retaining position and the first cord winding releasing position.

18. The apparatus of claim 15, wherein the first claw slides between the cord winding retaining position and the first cord winding releasing position.

19. The apparatus of claim 15, wherein the first hook comprises:
a second claw forming a second cord winding receiving recess; and
a second mount removably mounting the second claw to the longitudinal structure;

20. The apparatus of claim 15, wherein the first claw is movable relative to the structure between a second cord winding retaining position forming a second cord winding receiving recess and a second cord winding releasing position

21. The apparatus of claim 14, wherein the first hook and the second hook are distinct components longitudinally spaced apart from one another along the structure.

22. The apparatus of claim 14, wherein the second hook is removable from the longitudinally extending structure.

23. The apparatus of claim 14, wherein the second hook is slidable relative to and along the longitudinally extending structure.

24. An apparatus comprising:
a first hook for use with a second hook to form first and second opposite lee facing cord winding receiving recesses, the first hook comprising:
a first base configured to be removably mounted to an electrically powered appliance;
at least one strap connected to the base and configured to mount the base to the electrically powered appliance; and
a first claw movably coupled to the first base, the first claw being movable relative to the first base between a cord winding retaining position forming one of the cord winding receiving recesses and a cord winding releasing position.

25. The apparatus of claim 24 further comprising an underpad opposite the base and connected to the base by the at least one strap.

26. The apparatus of claim 24 further comprising the second hook, wherein the second hook is identical to the first hook.

27. The apparatus of claim 24, wherein the first claw pivots between the cord winding retaining position and the cord winding releasing position.

28. The apparatus of claim 24, wherein the first hook additionally comprises a threaded adjustment mechanism coupled to the strap such that rotation of the threaded adjustment mechanism further tightens the strap about the electrically powered appliance.

29. The apparatus of claim 28, wherein the threaded adjustment mechanism includes a point facing the strap and configured to be drawn towards and into contact with the electrically powered appliance as the strap is tightened about the electrically powered appliance.

30. A method comprising:
wrapping an extension cord having a male plug and a female plug around one or more hooks extending from an electrically powered appliance to store the extension cord on the electrically powered appliance.
